(19) United States
(12) Patent Application Publication
(10) Pub. No.: US 2007/0164653 A1
(43) Pub. Date: Jul. 19, 2007

(54) Field emission type backlight unit and method of manufacturing upper panel thereof

(76) Inventors: Byong-Gwon Song, Seoul (KR); Shang-Hyeun Park, Boryeong-si (KR); Yong-Wan Jin, Seoul (KR); Sun-Il Kim, Suwon-si (KR); Tae-Won Jeong, Seoul (KR)

Correspondence Address: Robert E. Bushnell;Suite 300, 1522 K. Street, N.W., Washington, DC, 20005, US

(21) Appl. No.: 11/509,622

(22) Filed: Aug. 25, 2006

(30) Foreign Application Priority Data
Jan. 13, 2006 (KR) 10-2006-0003937

(51) Int. Cl. H01J 63/04; H01J 1/62; B05D 5/12

(52) U.S. Cl. 313/495; 313/497; 427/58

(57) ABSTRACT

A method of manufacturing an upper panel of a field emission type backlight unit. The method includes: sequentially forming an anode electrode and a phosphor layer on a substrate; forming a metal reflection film on the phosphor layer; and annealing a surface of the metal reflection film. The method can increase brightness of an image, can prevent occurrence of an electric arc when a high driving voltage is applied to the backlight unit, and allows removal of residues produced when manufacturing the backlight unit.

### CLAIM OF PRIORITY

This application makes reference to, incorporates the same herein, and claims all benefits accruing under 35 U.S.C. §119 from an application for FIELD EMISSION TYPE BACKLIGHT UNIT, AND MANUFACTURING METHOD OF UPPER PANEL THEREOF earlier filed in the Korean Intellectual Property Office on 13 Jan. 2006 and there duly assigned Serial No. 10-2006-0003937.

### BACKGROUND OF THE INVENTION

1. Field of the Invention

The present invention relates to a field emission type backlight unit and a method of manufacturing an upper panel thereof, and more particularly, to a field emission type backlight unit that can improve brightness of an image, can prevent an arc discharge when a high voltage is applied thereto, and from which manufacturing residues can be removed, and a method of manufacturing an upper panel of a field emission type backlight unit.

2. Description of the Related Art

Flat panel display devices can typically be divided into emissive display devices and passive display devices. Emissive display devices include cathode ray tubes (CRTs), plasma display panels (PDPs), and field emission display (FED) devices, and passive display devices include liquid crystal display (LCD) devices. Of the devices, the LCD device has the advantages of light weight and low power consumption, but is a passive display device. That is, the LCD device displays an image using light from an external device, and cannot generate its own light. Therefore, the image displayed cannot be seen in a dark place. To address this problem, a backlight unit is installed behind the LCD devices to radiate light and allow a user to see an image displayed on the LCD in a dark place.

Conventional backlight units mainly use cold cathode fluorescent lamps (CCFLs) as a line luminescent source and light emitting diodes (LEDs) as a point luminescent source. Conventional backlight units, however, have high manufacturing costs due to their structural complexity, and high power consumption due to reflection and transmittance of light since the light source is located at a side of the backlight unit. In particular, as the size of an LCD device increases, it is more difficult to obtain uniform brightness.

Accordingly, to address the above problems, a field emission type backlight unit having a flat emission structure has been proposed. The field emission type backlight unit has lower power consumption compared to a conventional backlight unit that uses a CCFL and also has a relatively uniform brightness in a wide range of light emission region.

In a conventional field emission type backlight unit, an upper substrate and a lower substrate face each other. An anode electrode is formed on a lower surface of the upper substrate, and a phosphor layer is formed on a lower surface of the anode electrode.

When light is emitted from the phosphor layer to the outside through the upper substrate, a portion of light is emitted through the lower substrate, thereby reducing the light emission efficiency of the backlight unit.

Furthermore, when a high driving voltage is applied to the backlight unit, residues of the anode electrode and the phosphor layer will remain on the upper substrate, as a product of a manufacturing process, and vaporize into ions. As a result, an ion current that may cause an electrical arc is generated, and the gate electrodes, the cathode electrodes and the emitter can be damaged.

### SUMMARY OF THE INVENTION

It is therefore, an object of this invention to provide an improved backlight unit and an improved process for manufacturing backlight units.

The present invention provides a backlight unit that can enhance brightness of an image and a method of manufacturing an upper panel of a backlight unit.

The present invention also provides a backlight unit from which manufacturing residues can be removed and a method of manufacturing an upper panel of a backlight unit.

The present invention additionally provides a backlight unit than can prevent the generation of an electrical arc when a high driving voltage is applied to the backlight unit and a method of manufacturing an upper panel of a backlight unit.

According to one aspect of the present invention, a method of manufacturing an upper panel of a field emission type backlight unit is provided to sequentially form an anode electrode and a phosphor layer on a substrate, form a metal reflection film on the phosphor layer, and anneal a surface of the metal reflection film.

The annealing of the metal reflection film may be performed at a temperature lower than a softening point of a material for forming the metal reflection film.

The metal reflection film may be made from Al, and the annealing may be performed while the Al reflection film is maintained at a temperature of between approximately 500° C. to approximately 600° C.

The surface of the metal reflection film may be annealed using a laser irradiation method or a rapid thermal annealing (RTA) method.

The laser may be a continuous wave laser.

The method may further, between the sequentially formation of the anode electrode and the phosphor layer on the substrate and the formation of the metal reflection film on the phosphor layer, form a decomposable film that forms an air gap between the phosphor layer and the metal reflection film and planarizes the metal reflection film.

The method may also, between the sequentially formation of the anode electrode and the phosphor layer on the substrate and the formation of the metal reflection film on the phosphor layer, form a prewet solution that further planarizes the metal reflection film before forming of the decomposable film.

The method may, between the formation of the metal reflection film on the phosphor layer and the annealing of a surface of the metal reflection film, thermally decompose the decomposable film at a high temperature, form air gaps in the metal reflection film, and exhaust a gas resulting from the thermally decomposed film through the air gaps.

According to another aspect of the present invention, a field emission type backlight unit is provided, the field emission type backlight unit may be constructed with an upper substrate and a lower substrate facing each other and spaced apart from each other; an anode electrode formed on a lower surface of the upper substrate; a phosphor layer formed on a lower surface of the anode electrode; a metal reflection film formed on a lower surface of the phosphor layer and planarized by annealing; a plurality of cathode electrodes and gate electrodes alternately formed on an upper surface of the lower substrate; and an emitter formed at least on the cathode electrode of the cathode electrode and the gate electrode.

According to still another aspect of the present invention, a field emission type backlight unit is provided with the field emission type backlight unit may be constructed with an upper substrate and a lower substrate facing each other and spacing apart from each other; an anode electrode formed on a lower surface of the upper substrate; a phosphor layer formed on a lower surface of the anode electrode; a metal reflection film formed on a lower surface of the phosphor layer and planarized by annealing; a cathode electrode formed on an upper surface of the lower substrate; an insulating layer that is formed on the upper surface of the lower substrate and has a cavity that exposes the cathode electrode; a gate electrode that is formed on the insulating layer and has a gate hole corresponding to the cavity in the insulating layer; and an emitter formed on the cathode electrode.

The field emission type backlight unit may also place a decomposable film, between the phosphor layer and the metal reflection film, which is predestined to from air gaps between the phosphor layer and the metal reflection film and planarizes the metal reflection film.

The field emission type backlight unit may further dispose a prewet solution between the phosphor layer and the decomposable film, which enhances the planarization of the metal reflection film.

The metal reflection film may be made from Al.

The emitter may be formed by carbon nanotubes.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view of a contemporary field emission type backlight unit;

FIGS. 2A through 2D are cross-sectional views showing a method for manufacturing an upper panel of a backlight unit as an embodiment of the principles of the present invention;

FIGS. 3A and 3B are cross-sectional views illustrating a backlight unit constructed as an embodiment of the principles of the present invention;

FIG. 4 is a graph showing a brightness characteristic varying according to the thickness of a metal reflection film of the upper panel of a backlight unit manufactured according to the method of FIGS. 2A and 2B;

FIGS. 5A and 5B are photographs showing a morphology of the metal reflection film when a surface annealing process of FIG. 2C is omitted while manufacturing an upper panel of a backlight unit as an embodiment of the present invention; and

FIGS. 6A and 6B are photographs showing morphologies of the metal reflection film of an upper panel of a backlight unit manufactured using the method illustrated by FIGS. 2A through 2C.

### DETAILED DESCRIPTION OF THE INVENTION

A field emission type backlight unit and a method of manufacturing an upper panel thereof according to the present invention will now be described more fully with reference to the accompanying drawings.

FIG. 1 is a schematic cross-sectional view of a contemporary field emission type backlight unit constructed with an upper substrate 20 and a lower substrate 10 that face each other and are spaced apart from each other. An anode electrode 22 is formed on a lower surface of upper substrate 20, and a phosphor layer 24 is formed on a lower surface of anode electrode 22. A plurality of cathode electrodes 12 and a plurality of gate electrodes 15 spaced apart and parallel to each other are formed on an upper surface of lower substrate 10. Here, cathode electrodes 12 and gate electrodes 15 are alternately formed on the same plane. Cathode electrodes 12 and gate electrodes 15 are formed of thin films having a thickness of between 1000 Å to 3000 Å. A plurality of emitters 17 made from an electron emission material, such as carbon nanotubes, are formed on both sides of cathode electrodes 12.

Although it is not depicted, a plurality of spacers are formed between lower substrate 10 and upper substrate 20 to uniformly maintain a gap between lower substrate 10 and upper substrate 20. In the above structure, when a voltage is applied between cathode electrodes 12 and gate electrodes 15, electrons are emitted from emitters 17 disposed on both sides of cathode electrodes 12. The electrons are accelerated by a voltage applied to anode electrode 22 toward anode electrode 22 and excite phosphor layer 24 to emit visible light.

When light is emitted from phosphor layer 24 to the outside through upper substrate 20, a portion of light is emitted through lower substrate 10, thereby reducing the light emission efficiency of the backlight unit.

Furthermore, when a high driving voltage is applied to the backlight unit, residues of anode electrode 22 and phosphor layer 24 remaining in upper substrate 20, which are produced during a manufacturing process, may vaporize into ions. As a result, an ion current that can cause an electrical arc may be generated. In this case, gate electrodes 15, cathode electrodes 12, and emitter 17 can be damaged.

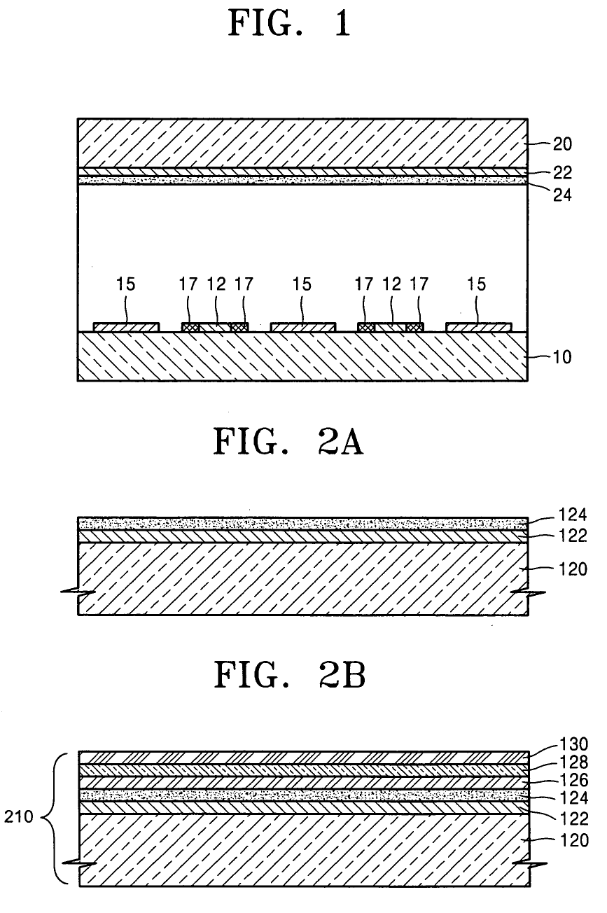

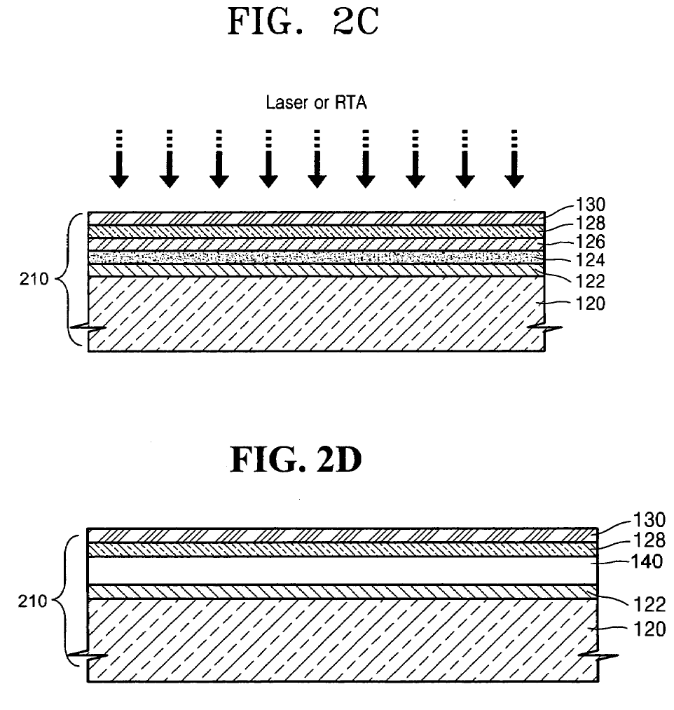

FIGS. 2A through 2D are cross-sectional views showing a method for manufacturing an upper panel 210 of a backlight unit as an embodiment of the present invention.

Hereinafter, the method of manufacturing an upper panel 210 of a backlight unit constructed as an embodiment of the present invention will now be described with reference to FIGS. 2A through 2C.

First, an anode electrode 122 and a phosphor layer 124 are sequentially formed on an upper substrate 120. Upper substrate 120 maybe a common transparent substrate such as a glass substrate.

Anode electrode 122 may be formed of a transparent conductive material such as indium tin oxide (ITO) so that light emitted from phosphor layer 124 can pass through. Anode electrode 122 can be formed on the entire surface of upper substrate 120 as a thin film, or can be formed on a portion of upper substrate 120 in a predetermined pattern such as a stripe pattern. Phosphor layer 124 can be formed by respectively coating red R, green G, and blue B phosphor materials in a predetermined pattern on a surface of anode electrode 122, or can be formed by coating the red R, green G, and blue B phosphor materials in a mixed state on the entire surface of anode electrode 122.

Next, a decomposable film 128 is formed on a surface of phosphor layer 124 to planarize phosphor layer 124 before a metal reflection film 130, which will be described later, is formed. Decomposable film 128 can be decomposed by high temperature and can form an air gap 140 between phosphor layer 124 and metal reflection film 130 so that metal reflection film 130 can reflect light like a mirror. Decomposable film 128 can be formed by coating a filming solution manufactured by mixing at least two materials selected from a group of butyl methacrylate (BMA), acryloide, toluene, methyl isobutyl ketone (M.I.B.K), methyl ethyl ketone (M.E.K), ethyl acetate, iso-amyl acetate, dibutyl phthalate, nitro cellulose, etc., on a surface of phosphor layer 124.

Next, to further planarize metal reflection film 130, a prewet solution 126 can be formed prior to forming decomposable film 128. Prewet solution 126 is water soluble and instantly forms an interface with decomposable film 128 to form a thin film on a surface of the red R, green G, and blue B phosphor layers 124. Prewet solution 126 is formed of at least one material selected from a group of polyvinyl alcohol (PVA), colloidal silica, triton, acetic acid, etc.

A planarized metal reflection film 130 can be realized when metal reflection film 130 is formed on phosphor layer 124, of which non-uniformity of the surface is reduced by decomposable film 128. When metal reflection film 130 is planarized, the reflection capability of metal reflection film 130 increases. That is, of the light emitted from phosphor layer 124, part of the light proceeding in a direction away from upper substrate 120 is reflected by metal reflection film 130 to proceed toward upper substrate 120, thereby increasing the reflection rate of the light.

If metal reflection film 130 is directly deposited on a surface of phosphor layer 124, molecules of the source metal can infiltrate into a gap between particles of phosphor layer 124. As a result, the advantage of forming metal reflection film 130 is lost because the light emission capability of phosphor layer 124 is reduced.

As described above, metal reflection film 130 increases the brightness characteristic of the backlight unit by reflecting the part of the visible light that is emitted from phosphor layer 124 and proceeds toward the lower substrate (not shown), so that the visible light can proceed toward upper substrate 120. In the present embodiment, metal reflection film 130 is formed of Al, but the present invention is not limited to Al. That is, various materials that have superior light reflection capability can be used.

Next, the resultant product is baked at a predetermined high temperature, for example, at a temperature of approximately 450° C. During the baking process, decomposable film 128 is thermally decomposed, generating air gaps 140 between metal reflection film 130 and phosphor layer 124. The thermally decomposed film 128 produces a gas that is exhausted through air gaps 140.

Even though the baking process is performed, however, residues of prewet solution 126 or decomposable film 128 remaining between upper substrate 120 and metal reflection film 130, more specifically, between phosphor layer 124 and metal reflection film 130, are not completely removed. The residues rapidly ionize by vaporizing when a high driving voltage is applied to the backlight unit, and thus generate an ion current that may cause an electrical arc. Thus, a gate electrode, a cathode electrode, and an emitter, which will be described later, can be damaged by the electrical arc.

When the baking process is completed, metal reflection film 130 is planarized entirely. Partly non-uniform shapes including a peg shape remain on metal reflection film 130. In this case, when a high driving voltage is applied to the backlight unit, an electric arc can be produced, which damages the emitter, the gate electrode, and the cathode electrode on the lower substrate.

To reduce the possibility of the production of the electric arc, the surface of metal reflection film 130 is annealed after the baking process. The surface annealing is performed in a temperature range in which the temperature of metal reflection film 130 can be maintained at a lower temperature than a softening point of the material that forms metal reflection film 130. That is, if metal reflection film 130 is formed of Al, the annealing can be performed at approximately 600° C., which is the softening temperature of Al, or less, preferably, at a temperature of, between approximately 500° C. to approximately 600° C.

The surface annealing is performed by a laser or rapid thermal annealing (RTA) method. When the surface is annealed using the RTA method, heat is irradiated onto metal reflection film 130 at a temperature of approximately 500° C. to 700° C. for approximately 30 seconds to 3 minutes using a heat lamp. When the surface is annealed using the laser method, a continuous wave laser can be used, but the present invention is not limited thereto. Also, the annealing of the surface of metal reflection film 130 can be performed directly from the side of metal reflection film 130, but the present invention is not limited to this arrangement. That is, the annealing can be performed from the side of the upper substrate until the annealing effect reaches metal reflection film 130.

When metal reflection film 130 is annealed as described above, the non-uniform portions including the peg shape remaining on metal reflection film 130 are removed. Accordingly, the electrical arc does not occur when a high driving voltage is applied to the backlight unit.

The stacking structure of the backlight unit, from upper substrate 120 to metal reflection film 130, is referred to as upper panel 210 of the backlight unit.

A backlight unit 200 fabricated as an embodiment of the preset invention, backlight unit 200 having upper panel 210 manufactured using the method described above, will now be described.

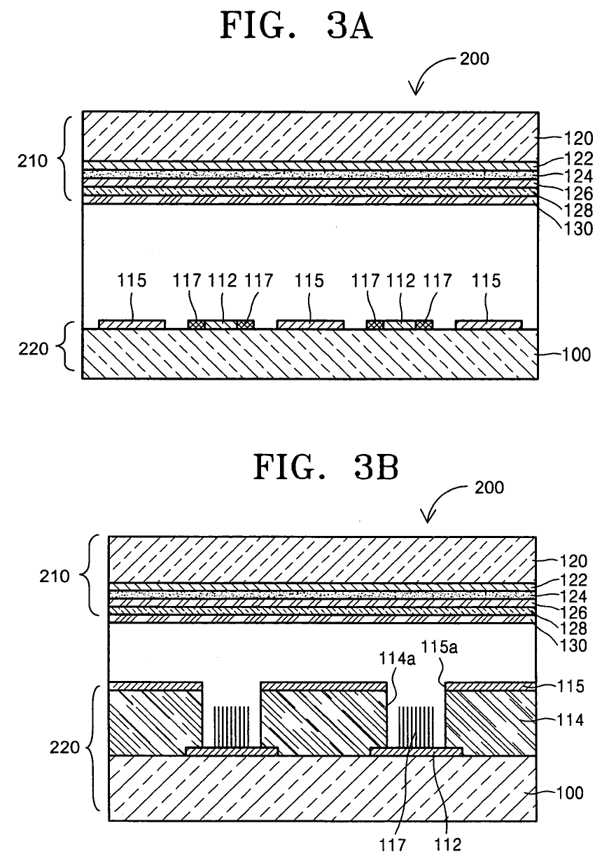

FIGS. 3A and 3B are cross-sectional views of backlight unit 200. Like reference numerals in the previous drawing denote like elements.

Referring to FIG. 3A, an upper panel 210 has a structure in which an upper substrate 120, an anode electrode 122, a phosphor layer 124, a prewet solution 126, a decomposable film 128, and a metal reflection film 130 are sequentially stacked. Prewet solution 126 or decomposable film 128 can be partially or entirely removed through a baking process followed by a process of annealing the surface of metal reflection film 130. Alternatively, upper panel 210 may be constructed without either or both of prewet solution 126 and decomposable film 128

A lower panel 220 has the following structure in which a plurality of cathode electrodes 112 and a plurality of gate electrodes 115 are arranged parallel to each other and are formed on an upper surface of a lower substrate 100. Here, cathode electrodes 112 and gate electrodes 115 are alternately formed on the same plane. A plurality of emitters 117 formed of an electron emission material, for example, carbon nanotubes, are formed spaced-apart on both sides of cathode electrodes 112. Although it is not depicted, a plurality of spacers are formed between lower substrate 100 and upper substrate 120 to uniformly maintain a gap between lower substrate 100 and upper substrate 120.

The structure of lower panel 220, however, according to the principles of the present invention is not limited to the structure described above, and can have various structures. A structure of lower panel 220 constructed as another embodiment of the present invention is depicted in FIG. 3B. The structure of upper panel 210 is identical to that of FIG. 3A, thus the detailed description thereof will not be repeated.

Referring to FIG. 3B, cathode electrodes 112 having a stripe shape are formed on an upper surface of lower substrate 100. Cathode electrode 112 is formed as a thin film having a thickness of between approximately 1000 Å to approximately 3000 Å. Cathode electrode 112 is formed of a conductive material such as ITO through which ultraviolet rays pass.

An insulating layer 114 that exposes the cathode electrode 112, for example, an SiO₂ layer, is formed on lower substrate 100. Insulating layer 114 can be formed to have a thickness of approximately a few to a few tens μm. A cavity 114a that exposes cathode electrode 112 is formed in insulating layer 114. A gate electrodes 115 having a gate hole 115a corresponding to cavity 114a is formed on insulating layer 114. Gate electrode 115 is formed as a thin film having a thickness of approximately 1000 to 3000 Å. Gate electrode 115 may be formed of a conductive material such as Cr or Ag that does not allow ultraviolet rays to pass through.

Also, gate electrode 115 can be formed in a flat shape. The flat shaped gate electrode 115 prevents an arc discharge caused by electrons accumulated on insulating layer 114 colliding with anode electrode 122.

An emitter 117 that emits electrons by a voltage applied between cathode electrode 112 and gate electrode 115 is formed on cathode electrode 112 exposed through gate hole 115a. Emitter 117 is formed of an electron emission material such as CNTs. When emitter 117 is formed of CNTs, electrons can be emitted at a relatively low driving voltage.

Hereinafter, an operation of backlight unit 200 having the structure described above will now be described.

When a voltage is applied between cathode electrode 112 and gate electrode 115, electrons are emitted from emitter 117 formed on cathode electrode 112. The electrons are accelerated by a voltage applied to anode electrode 122, and collide with phosphor layer 124 to emit visible light. Most of the light emitted from phosphor layer 124 is emitted to the outside through upper substrate 120, but part of light proceeds toward lower substrate 100. The light proceeding toward lower substrate 100 is reflected by metal reflection film 130 to be emitted to outside through upper substrate 120, thereby increasing the brightness characteristic of backlight unit 200. Metal reflection film 130 has a planarized surface obtained through an annealing process. Therefore, no electrical arc occurs when a high driving voltage is applied to backlight unit 200.

Hereinafter, an exemplary embodiment of the present invention is described, but the present invention is not limited thereto.

### Brightness Test by Formation of a Metal Reflection Film

After the processes of FIGS. 2A and 2B were finished, a brightness test was performed prior to annealing the surface of metal reflection film 130 of FIG. 2C. Here, prewet solution 126 was not coated and decomposable film 128 was formed to a thickness of 30 μm.

First, electrons are directly shot toward metal reflection film 130 to make phosphor layer 124 emit visible light. At this time, an acceleration voltage was 8 KV and a current density was 10 μ/cm². Next, brightness was measured using a BM7 brightness meter from TOPCON Co. when the visible light was emitted to the outside.

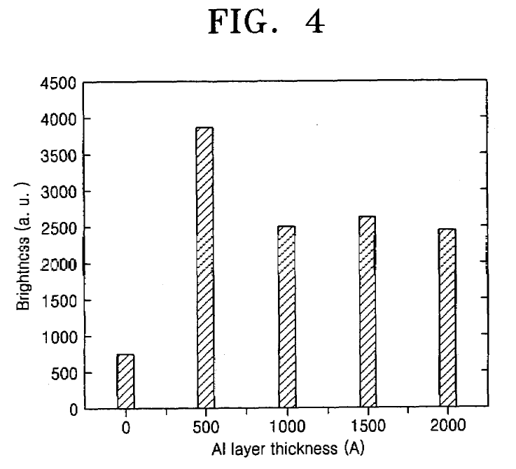

The brightness measurements were repeated several few times by varying the thickness of the metal reflection film 130. The test results are shown in FIG. 4.

FIG. 4 is a graph showing a brightness characteristic of a backlight unit according to the thickness of a metal reflection film of upper the panel of a backlight unit manufactured according to the method of FIGS. 2A and 2B.

Referring to FIG. 4, when the backlight unit has a metal reflection film 130, here, an Al film, the brightness of the backlight unit is increased compared to a backlight unit without metal reflection film 130. Moreover, when metal reflection film 130 has an optimum thickness, brightness increases. If metal reflection film 130 has a thickness greater than the optimum thickness, brightness is reduced. In the present embodiment, the optimum thickness of metal reflection film 130 was approximately 500 Å. The optimum thickness of metal reflection film 130, however, may vary according to the material for forming metal reflection film 130.

### Test of Surface Annealing Effect of the Metal Reflection Film

### When the Surface is Not Annealed

When the surface of metal reflection film 130 is not annealed after the formation of metal reflection film 130, surface conditions of phosphor layer 124 and metal reflection film 130 were observed as follows.

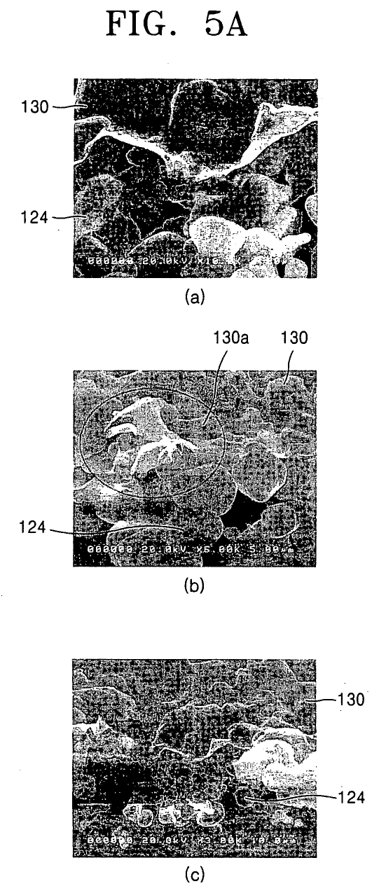

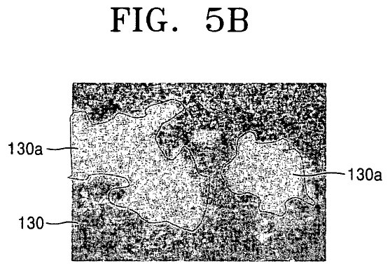

FIGS. 5A and 5B are photographs showing the morphology of metal reflection film 130 when a surface annealing process of FIG. 2C is omitted during the manufacturing of an upper panel 210 of a backlight unit 200 fabricated as an embodiment of the present invention.

In the drawings, like reference numerals refer to like elements.

Photographs in FIG. 5A are SEM images and photographs in FIG. 5B are images taken using a CCD camera.

The photographs of (a), (b), and (c) in FIG. 5A show the surface states of metal reflection film 130 in various angles.

As depicted in FIGS. 5A and 5B, metal reflection film 130 is formed on phosphor layer 124. Although the entire metal reflection film 130 is planarized, non-uniform portions 130a exist, as depicted in FIG. 5B. Also, non-uniform portions 130a of metal reflection film 130, as depicted in FIG. 5A, have a peg shape or a wedge shape. As described above, non-uniform portions 130a of metal reflection film 130 cause an electrical arc, which damages the emitters, etc., when a high driving voltage is applied to the backlight unit.

### When the Surface is Annealed

When the surface of metal reflection film 130 is annealed after forming metal reflection film 130, surface conditions of phosphor layer 124 and metal reflection film 130 were observed as follows.

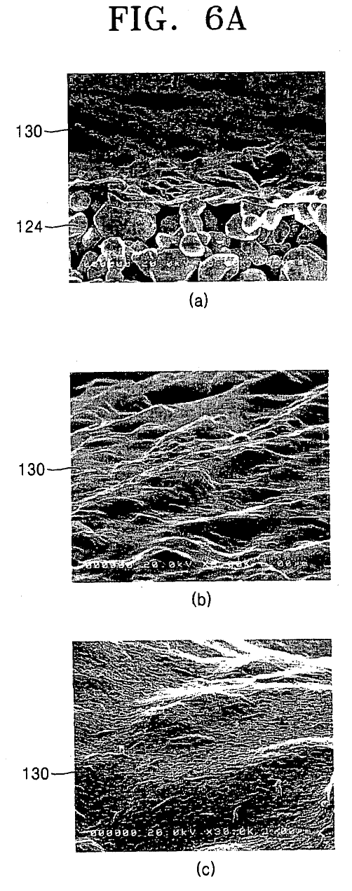

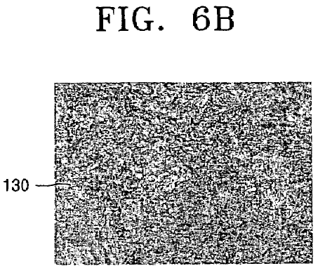

FIGS. 6A and 6B are photographs showing morphologies of the metal reflection film of an upper panel of a backlight unit manufactured using the method of FIGS. 2A through 2C.

In the drawings, like reference numerals refer to like elements.

First, surface annealing of metal reflection film 130 is performed using laser annealing. Upper substrate 120 was a glass substrate, and metal reflection film 130 was an Al film. Decomposable film 128 was formed to have a thickness of approximately 30 μm. The laser source was Nd:YAG and a continuous wave laser having a wavelength of 1064 nm was used. The laser beam had a diameter of 5 mm, scanning speed was 1 to 20 cm/sec., and laser power was between 1 W and 10 W.

Next, the surfaces of metal reflection film 130 and phosphor layer 124 were photographed using a SEM and CCD camera. Photographs in FIG. 6A are SEM images and photographs in FIG. 6B are images taken using a CCD camera. The photographs of (a), (b), and (c) in FIG. 6A show the surface states of metal reflection film 130 in various angles.

Referring to FIGS. 6A and 6B, the entire metal reflection film 130 is planarized, and non-uniform portions 130a formed in FIGS. 5A and 5B are removed.

When the surface of metal reflection film 130 is annealed, no electrical arc occurs even if a high driving voltage is applied to backlight unit 200, thereby preventing the damage of the emitter, etc. Here, although it is not specifically described, when metal reflection film 130 is annealed, decomposable film 128 is thermally decomposed by the high annealing temperature and removed. Therefore, as described above, the possibility of generating an ion current due to the vaporization and ionization of residues is prevented. Accordingly, the possibility of causing an electrical arc due to the ion current is also prevented.

The present invention provides a backlight unit having increased brightness characteristic and a method of manufacturing an upper panel thereof.

The present invention also provides a backlight unit from which manufacturing residues can be removed and a method of manufacturing an upper panel thereof.

The present invention also provides a backlight unit than can prevent the generation of an electrical arc when a high driving voltage is applied to the backlight unit and a method of manufacturing an upper panel thereof.

While the present invention has been particularly shown and described with reference to exemplary embodiments thereof, it will be understood by those of ordinary skill in the art that various changes in form and details maybe made therein without departing from the spirit and scope of the present invention as defined by the following claims.

1. A method of manufacturing an upper panel of a field emission type backlight unit, the method comprising:
sequentially forming an anode electrode and a phosphor layer on a substrate;
forming a metal reflection film on the phosphor layer; and
annealing the metal reflection film.

2. The method of claim 1, comprised of annealing the metal reflection film at a temperature lower than a softening point of a material for forming the metal reflection film.

3. The method of claim 2, with the metal reflection film made from Al, comprised of annealing the Al reflection film while maintaining the temperature of the Al reflection film within a range between approximately 500° C. to 600° C.

4. The method of claim 1, comprised of annealing the surface of the metal reflection film with one of a laser irradiation method and a rapid thermal annealing (RTA) method.

5. The method of claim 4, with the laser comprising a continuous wave laser.

6. The method of claim 1, further comprised of, between sequential formation of the anode electrode and the phosphor layer on the substrate and formation of the metal reflection film on the phosphor layer, forming a decomposable film that creates an air gap between the phosphor layer and the metal reflection film and that planarizes the metal reflection film.

7. The method of claim 6, further comprising, between sequential formation of the anode electrode and the phosphor layer on the substrate and formation of the metal reflection film on the phosphor layer, forming a prewet solution that further planarizes the metal reflection film before forming the decomposable film.

8. The method of claim 1, further comprising, between formation of the metal reflection film on the phosphor layer and annealing of the surface of the metal reflection film, thermally decomposing the decomposable film by increasing the temperature of the film, creating air gaps in the metal reflection film, and exhausting a gas resulting from thermally decomposition of the decomposable film through the air gaps.

9. A field emission type backlight unit, comprising:
an upper substrate and a lower substrate facing each other and spaced apart from each other;
an anode electrode formed on a lower surface of the upper substrate;
a phosphor layer formed on a lower surface of the anode electrode;
a metal reflection film formed on a lower surface of the phosphor layer and planarized by annealing;
a plurality of cathode electrodes and gate electrodes alternately formed on an upper surface of the lower substrate; and
an emitter formed at least on the cathode electrode of the cathode electrode and the gate electrode.

10. The field emission type backlight unit of claim 9, further comprising a decomposable film disposed between the phosphor layer and the metal reflection film, that creates air gaps between the phosphor layer and the metal reflection film and planarizes the metal reflection film.

11. The field emission type backlight unit of claim 10, further comprising a prewet solution disposed between the phosphor layer and the decomposable film, that further planarizes the metal reflection film.

12. The field emission type backlight unit of claim 9, with the metal reflection film being comprised of Al.

13. The field emission type backlight unit of claim 9, with the emitter being formed from carbon nanotubes.

14. A field emission type backlight unit, comprising:
an upper substrate and a lower substrate facing each other and spaced apart from each other;
an anode electrode formed on a lower surface of the upper substrate;
a phosphor layer formed on a lower surface of the anode electrode;
a metal reflection film formed on a lower surface of the phosphor layer and planarized by annealing;
a cathode electrode formed on an upper surface of the lower substrate;
an insulating layer that is formed on the upper surface of the lower substrate and has a cavity that exposes the cathode electrode;
a gate electrode that is formed on the insulating layer and has a gate hole corresponding to the cavity in the insulating layer; and
an emitter formed on the cathode electrode.

15. The field emission type backlight unit of claim 14, further comprising a decomposable film disposed between the phosphor layer and the metal reflection film, that creates air gaps between the phosphor layer and the metal reflection film and planarizes the metal reflection film.

16. The field emission type backlight unit of claim 15, further comprising a prewet solution disposed between the phosphor layer and the decomposable film, that further planarizes the metal reflection film.

17. The field emission type backlight unit of claim 14, with the metal reflection film being comprised of Al.

18. The field emission type backlight unit of claim 14, with the emitter being formed from carbon nanotubes.

19. The method of claim 1, with the substrate comprising a glass substrate.

20. The method of claim 1, with the anode electrode comprising indium tin oxide (ITO).

21. The method of claim 6, with the decomposable film being formed by mixing at least two materials selected from a group consisting essentially of butyl methacrylate (BMA), acryloide, toluene, methyl isobutyl ketone (M.I.B.K), methyl ethyl ketone (M.E.K), ethyl acetate, iso-amyl acetate, dibutyl phthalate and nitro cellulose.

22. The method of claim 7, with the prewet solution being formed of at least one material selected from a group consisting essentially of polyvinyl alcohol (PVA), colloidal silica, triton and acetic acid.

23. The field emission type backlight unit of claim 9, comprising said emitter being formed on a side of the cathode.

24. The field emission type backlight unit of claim 9, comprising said emitter being formed on a top of the cathode.

25. The field emission type backlight unit of claim 9, comprising said emitter being formed on a side of the cathode and on a side of the gate electrode.

26. The field emission type backlight unit of claim 9, comprising said emitter being formed on a top of the cathode and on a top of the gate electrode.
